(19) United States
(12) Patent Application Publication
(10) Pub. No.: US 2016/0232815 A1
(43) Pub. Date: Aug. 11, 2016

(54) EXPOSED BULLY CARD GAME

(71) Applicant: Veronica Cochrum, Cincinnati, OH (US)

(72) Inventor: Veronica Cochrum, Cincinnati, OH (US)

(21) Appl. No.: 15/016,531

(22) Filed: Feb. 5, 2016

Related U.S. Application Data
(60) Provisional application No. 62/112,656, filed on Feb. 6, 2015.

(51) Int. Cl. G09B 19/22; A63F 1/00

(52) U.S. Cl. CPC G09B 19/22; A63F 1/00

(57) ABSTRACT

A playing card game educates players about bullying behaviors while providing entertainment. A playing card deck includes trivia cards as well as cards in categories of target or bully in settings of domestic, disable, workplace, classroom and cyberspace. Players draw undealt cards in turn in order to lay down a target or bully spread of unique target or bully category cards respectively. Other players can cancel the spread with an informer/snitch card or exposed card, respectively and obtain gaming chips from the player. Drawing a trivia card affords and opportunity to learn facts about bullying behavior. The player with the most gaming chips after five rounds wins. In one or more embodiments, the game may be based on an electronic game system including over the internet, video gaming devices or any digital application that plays cards. Also, play of an electronic card game can be scored in any denomination of scoring, counting, digital-based chips, currency, credit, or monetary value.

### CROSS-REFERENCE TO RELATED APPLICATIONS

This application claims the benefit of U.S. Provisional Application No. 62/112,656, entitled “EXPOSED BULLY CARD GAME” filed Feb. 6, 2015, the disclosure of which is incorporated herein by reference in its entirety.

### BACKGROUND OF THE INVENTION

1. Field of the Invention

The field of art disclosed herein pertains to card games, and more particularly for educational card games played with chips.

2. Description of the Related Art

A playing card is a piece of specially prepared heavy paper, thin cardboard, plastic-coated paper, cotton-paper blend, or thin plastic, marked with distinguishing motifs and used as one of a set for playing card games. Playing cards are typically palm-sized for convenient handling. A complete set of cards is called a pack, deck, or set, and the subset of cards held at one time by a player during a game is commonly called a hand. A pack of cards may be used for playing a variety of card games, with varying elements of skill and chance, some of which are played for money. Playing cards are also used for illusions, cardistry, building card structures, cartomancy and memory sport. Dedicated deck card games have sets that are used only for a specific game. In some instances, chips are used in conjunction of a deck of cards for betting.

While card games can have value as a source of entertainment, there are societal and behavioral problems that exist that also warrant attention. A need exists to educate people as to these societal and behavioral problems, such as those associated with bullying targets in contexts such as in the home (domestic), workplace, classroom, disabilities center and in cyberspace.

### SUMMARY OF THE INVENTION

In one aspect, the present disclosure provides a playing card game that uses a deck of playing cards including two or more of cards each of a first subset of target categories, two or more of cards each of a second subset of bully categories, at least one snitch/informer card to cancel a played spread of the first subset of target categories, and at least one exposed card to cancel a played spread of the second subset of bully categories. In addition, the playing card game includes game chips that are earned and lost by canceling the played spreads.

In another aspect, the present disclosure provides a method of playing a game with a playing card deck including two or more of cards each of a first subset of target categories, two or more of cards each of a second subset of bully categories, and at least one snitch/informer card, and at least one exposed card and with game chips. In one embodiment, the method includes dealing a hand a first number of cards from the playing card deck to two or more players. The method includes providing a second number of game chips to each of the two or more players. The method includes taking turns for each of the two more players for a third number of rounds by: drawing an undealt card from a remainder of the playing card deck; laying down a spread of a unique cards all taken from the first subset of target categories or all taken from the second subset of bully categories; receiving respectively the snitch/informer card or the exposed card if held by another player on the spread respectively comprised of the first subset of target categories or the second subset of bully categories; and in response to receiving the snitch/informer card or exposed card, cancelling the spread by giving the other player a fourth number of game chips that are held by the player. The method further includes declaring a player with the most game chips as winner of the game after the third number of rounds.

In an additional aspect, the present disclosure provides a method of playing a game with a playing card deck including three cards each of a first subset of target categories of domestic, disable, workplace, classroom, and cyberspace, three cards each of a second subset of bully categories of domestic, disable, workplace, classroom, and cyberspace, four snitch/informer cards, and four exposed cards and with game chips. In one embodiment, the method includes dealing a hand, a first number of cards from the playing card deck to two to six players. The method includes providing a second number of game chips to each of the two or more players. The method includes taking turns for each of the two more players for a third number of rounds by: drawing an undealt card from a remainder of the playing card deck; laying down a spread of a unique cards all taken from the first subset of target categories or all taken from the second subset of bully categories; receiving respectively the snitch/informer card or the exposed card if held by another player on the spread respectively comprised of the first subset of target categories or the second subset of bully categories; and in response to receiving the snitch/informer card or exposed card, cancelling the spread by giving the other player a fourth number of game chips that are held by the player. The method further includes declaring a player with the most game chips as winner of the game after the third number of rounds.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a top diagrammatic view of a game played with two or more players and a exposed bully playing card deck and game chips, according to one or more embodiments;

FIG. 2 illustrates a diagrammatic view of playing a target spread during a player's turn when playing the game of FIG. 1, according to one or more embodiments;

FIG. 3 illustrates a diagrammatic view of playing a bully spread during a player's turn when playing the game of FIG. 1, according to one or more embodiments;

FIG. 4 illustrates a flow diagram of a method of playing a game using an exposed bully playing card deck and game chips, according to one or more embodiments;

FIG. 5 illustrates a block diagram of an information handling system (IHS) to execute an application for playing the game, according to one or more embodiments; and

FIG. 6 illustrates a timing diagram of an illustrative game play, according to one or more embodiments.

### DETAILED DESCRIPTION

Bullying behavior can create traumatic experiences for a target of the bullying. Unchecked, the bully can impair their long-term social development by engaging in bullying behaviors. Bullies and their targets as well as third party bystanders need to be aware of what behaviors should be deemed bullying as well as the proper responses to bullying. In particular, awareness needs to be raised about bullying in different settings, such as in a domestic home setting, school environment, workplace, disable setting, and cyberspace. By incorporating education about bullying into a playing card game, players are more likely to learn these lessons while being entertained.

In one embodiment, each player gets seven (7) cards per hand and ten (10) chips. The whole point of the game can be to get rid of all of your cards and end up with as many chips as possible. Getting four Exposed cards can result in an automatic win. A player can be automatically out of the game if they lose all chips. Variations of the game can include a rule that players cannot borrow or lend chips. Normally, the players each play five (5) hands or rounds. On ones turn, a player can either (1) Play a trivia card if they have one in hand instead of drawing a card; (2) Draw a card and then see if you can lay down a spread; and (3) A player can pick up a top discard card from a previous player BUT that player MUST use it in a spread and cannot be held. A special first turn play can include that if a trivia card comes up as first discard off of the draw pile, then the first person to right of dealer can buy it for two (2) game chips. With regard to a trivia card: (1) You can ask any person to ask you the question or you can ask the question of any person; (2) Win by answering correctly or by reading the question and getting an incorrect response; (3) Loser gives Winner two chips. A spread is three cards in your hand that either: (1) Three of the same, e.g., three bully cards or three target cards (three classroom, three domestic, three disabled, three workplace, or three cyber) OR (2) three of the five cards from either bullies or targets (e.g., one classroom, one domestic, one disabled, etc., and cannot have two of the same category, such as two classroom and one domestic). (3) If lay down three of one kind and a person has an exposed/snitch card, can play and cancel the spread. That person has to pay three chips to the person that played the exposed and 2 chips for a snitch card. (4) If no one can play an exposed/snitch card, then it cannot be played on subsequent hands. (5) If a player lays down three of five categories as a spread, can cancel at any time/any turn if play the other two category cards of the spread.

Turning now to the drawings, the detailed description set forth below in connection with the appended drawings is intended as a description of various configurations and is not intended to represent the only configurations in which the concepts described herein may be practiced. The detailed description includes specific details for the purpose of providing a thorough understanding of various concepts with like numerals denote like components throughout the several views. However, it will be apparent to those skilled in the art that these concepts may be practiced without these specific details. In some instances, well-known structures and components are shown in block diagram form in order to avoid obscuring such concepts.

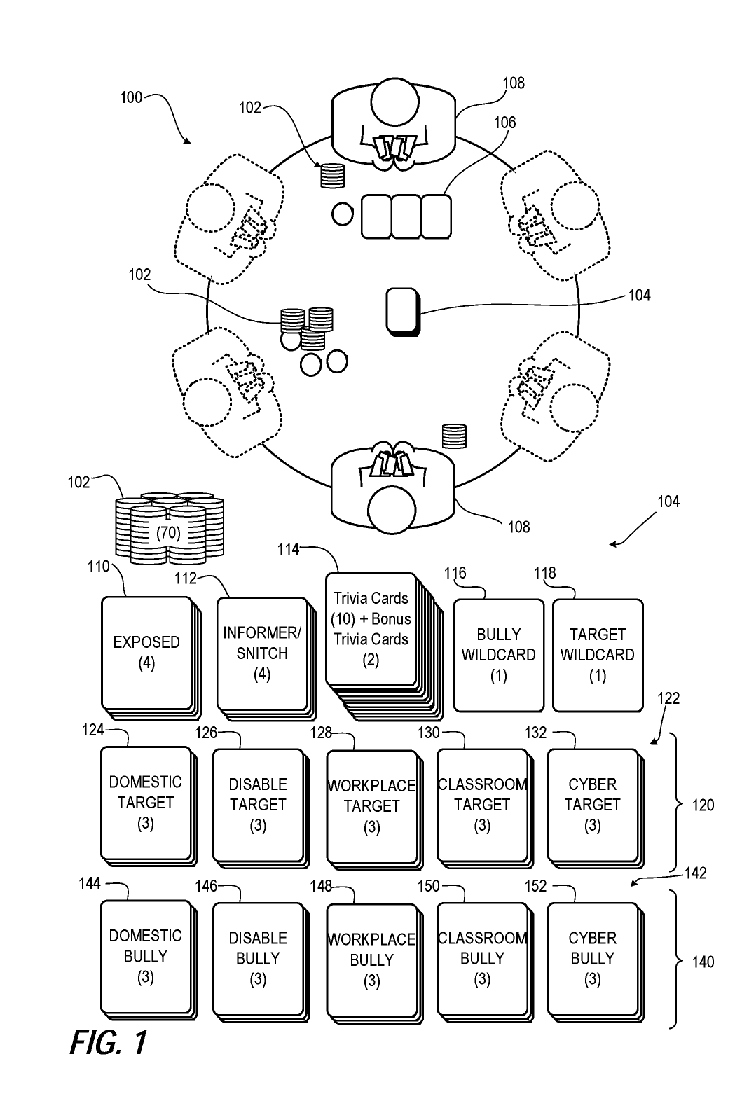

FIG. 1 illustrates a playing card game 100 that uses sixty (60) to seventy (70) game chips 102 and a playing card deck 104 of fifty-two (52) cards 106 that educates two (2) to six (6) players 108 as to various categories of bullying behavior. For clarity, the playing card game 100 can be physical playing cards 104 and game chips 102, although it should be appreciated that the game 100 can be implemented in a virtual environment such as allowing one person to play against computerized or remote players. In addition, the amount of playing cards 104 and game chips 102 can be varied to accommodate additional players. Game chips 102 can be virtual with players tabulating points in lieu of distributing physical game articles.

In an exemplary embodiment, the playing card deck 104 comprises four (4) exposed cards 110, four (4) informer/snitch cards 112, ten (10) trivia cards and two (2) bonus trivia cards 114, a bully wildcard 116, and a target wildcard 118. The playing card deck 104 further includes a first subset 120 of fifteen (15) target category cards 122 that comprise three (3) each domestic target cards 124, disable target cards 126, workplace target cards 128, classroom target cards 130, and cyber target cards 132. The playing card deck 104 further includes a second subset 140 of fifteen (15) bully category cards 142 that comprise three (3) each domestic bully cards 144, disable bully cards 146, workplace bully cards 148, classroom bully cards 150, and cyber bully cards 152.

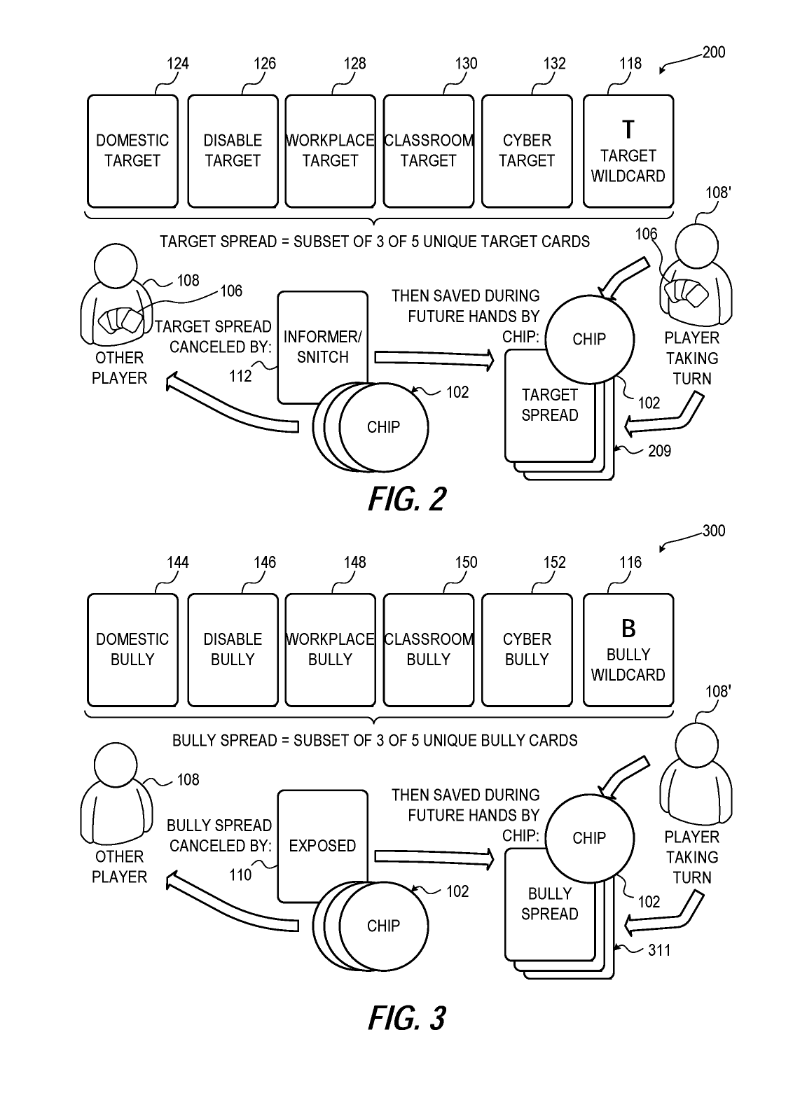

FIG. 2 illustrates a gameplay scenario 200 wherein a player 108 is taking his turn. In looking through his hand of cards 106, he finds a target spread 209 of three (3) of five (5) unique target category cards 122 in the target first subset 120, which can include a target wildcard 118 in lieu of any of the target category cards 122. Examples of possible target spreads 209 include:

TABLE 1

| | | | | |
|---|---|---|---|---|
| Domestic | Disable target | Workplace target | | |
| target | | | | |
| Domestic | Disable target | | Classroom | |
| target | | | target | |
| Domestic | Disable target | | | Cyber |
| target | | | | target |
| Domestic | | Workplace target | Classroom | |
| target | | | target | |
| Domestic | | Workplace target | | Cyber |
| target | | | | target |
| | Disable target | Workplace target | Classroom | |
| | | | target | |
| | Disable target | Workplace target | | Cyber |
| | | | | target |
| Target | Disable target | Workplace target | | |
| Wildcard | | | | |
| Target | Disable target | | Classroom | |
| Wildcard | | | target | |
| Target | Disable target | | | Cyber |
| Wildcard | | | | target |
| Target | | Workplace target | Classroom | |
| Wildcard | | | target | |
| Target | | Workplace target | | Cyber |
| Wildcard | | | | target |
| | Target | Workplace target | Classroom | |
| | Wildcard | | target | |
| | Target | Workplace target | | Cyber |
| | Wildcard | | | target |
| Domestic | Target | Workplace target | | |
| target | Wildcard | | | |
| Domestic | Target | | Classroom | |
| target | Wildcard | | target | |
| Domestic | Target | | | Cyber |
| target | Wildcard | | | target |
| Domestic | | Target Wildcard | Classroom | |
| target | | | target | |
| Domestic | | Target Wildcard | | Cyber |
| target | | | | target |
| | Disable target | Target Wildcard | Classroom | |
| | | | target | |
| | Disable target | Target Wildcard | | Cyber |
| | | | | target |
| Domestic | Disable target | Target Wildcard | | |
| target | | | | |
| Domestic | Disable target | | Target | |
| target | | | Wildcard | |
| Domestic | Disable target | | | Target |
| target | | | | Wildcard |
| Domestic | | Workplace target | Target | |
| target | | | Wildcard | |
| Domestic | | Workplace target | | Target |
| target | | | | Wildcard |
| | Disable target | Workplace target | Target | |
| | | | Wildcard | |
| | Disable target | Workplace target | | Target |
| | | | | Wildcard |
| Cyber Target | | | | |
| X3 | | | | |
| Cyber | | | | |
| TargetX2 + | | | | |
| Target | | | | |
| Wildcard | | | | |
| | Disable | | | |
| | Target X3 | | | |
| | Disable | | | |
| | Target X2 + | | | |
| | Target | | | |
| | Wildcard | | | |
| | | Workplace Target | | |
| | | X3 | | |
| | | Workplace Target | | |
| | | X2 + Target | | |
| | | Wildcard | | |
| | | | Classroom | |
| | | | Target X3 | |
| | | | Classroom | |
| | | | Target | |
| | | | X2 + | |
| | | | Target | |
| | | | Wildcard | |
| | | | | Cyber |
| | | | | Target |
| | | | | X3 |
| | | | | Cyber |
| | | | | Target |
| | | | | X2 + |
| | | | | Target |
| | | | | Wildcard |

In response to laying down the target spread 209 face up on the table, each other player 108 to the left of the player 108′ in turn is obligated to play an informer/snitch card 112 if held to cancel the target spread 109. In response to canceling the target spread 109, the player 108′ gives the other player 108 two (2) game chips 102. The player's turn then ends.

FIG. 3 illustrates a gameplay scenario 300 wherein a player 108′ is taking his turn. In looking through his hand of cards 106, he finds a bully spread 311 of three (3) of five (5) unique bully category cards 142 in the bully second subset 140, which can include a bully wildcard 116 in lieu of any of the bully category cards 142. Examples of possible bully spreads 311 include:

TABLE 2

| | | | | |
|---|---|---|---|---|
| Domestic bully | Disable bully | Workplace bully | | |
| Domestic bully | Disable bully | | Classroom | |
| | | | bully | |
| Domestic bully | Disable bully | | | Cyber bully |
| Domestic bully | | Workplace bully | Classroom | |
| | | | bully | |
| Domestic bully | | Workplace bully | | Cyber bully |
| | Disable bully | Workplace bully | Classroom | |
| | | | bully | |
| | Disable bully | Workplace bully | | Cyber bully |
| Bully Wildcard | Disable bully | Workplace bully | | |
| Bully Wildcard | Disable bully | | Classroom | |
| | | | bully | |
| Bully Wildcard | Disable bully | | | Cyber bully |
| Bully Wildcard | | Workplace bully | Classroom | |
| | | | bully | |
| Bully Wildcard | | Workplace bully | | Cyber bully |
| | Bully | Workplace bully | Classroom | |
| | Wildcard | | bully | |
| | Bully | Workplace bully | | Cyber bully |
| | Wildcard | | | |
| Domestic bully | Bully | Workplace bully | | |
| | Wildcard | | | |
| Domestic bully | Bully | | Classroom | |
| | Wildcard | | bully | |
| Domestic bully | Bully | | | Cyber bully |
| | Wildcard | | | |
| Domestic bully | | Bully Wildcard | Classroom | |
| | | | bully | |
| Domestic bully | | Bully Wildcard | | Cyber bully |
| | Disable bully | Bully Wildcard | Classroom | |
| | | | bully | |
| | Disable bully | Bully Wildcard | | Cyber bully |
| Domestic bully | Disable bully | Bully Wildcard | | |
| Domestic bully | Disable bully | | Bully Wildcard | |
| Domestic bully | Disable bully | | | Bully |
| | | | | Wildcard |
| Domestic bully | | Workplace bully | Bully Wildcard | |
| Domestic bully | | Workplace bully | | Bully |
| | | | | Wildcard |
| | Disable bully | Workplace bully | Bully Wildcard | |
| | Disable bully | Workplace bully | | Bully |
| | | | | Wildcard |
| Cyber bully X3 | | | | |
| Cyber bullyX2 + | | | | |
| Bully | | | | |
| Wildcard | | | | |
| | Disable bully | | | |
| | X3 | | | |
| | Disable bully | | | |
| | X2 + Bully | | | |
| | Wildcard | | | |
| | | Workplace bully X3 | | |
| | | Workplace bully | | |
| | | X2 + Bully | | |
| | | Wildcard | | |
| | | | Classroom | |
| | | | bully X3 | |
| | | | Classroom | |
| | | | bully X2 + | |
| | | | Bully Wildcard | |
| | | | | Cyber bully X3 |
| | | | | Cyber bully |
| | | | | X2 + Bully |
| | | | | Wildcard |

In response to laying down the bully spread 311 face up on the table, each other player 108 to the left of the player 108′ in turn is obligated to play an exposed card 112 if held to cancel the bully spread 111. In response to canceling the bully spread in, the player 108′ gives the other player 108 three (3) game chips 102. The player's turn then ends.

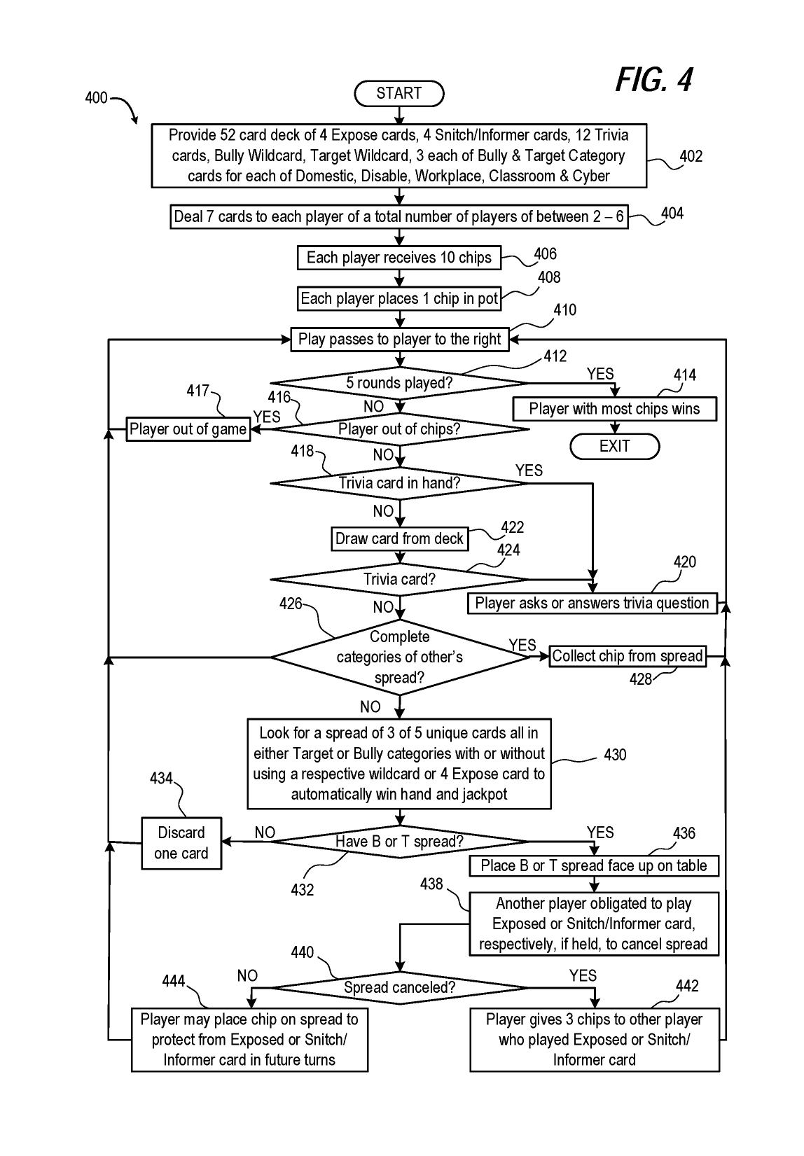

FIG. 4 illustrates a method 400 for playing a card game that educates the players about bullying behavior. In one embodiment, the method 400 includes providing a fifty-two (52) card deck of four (4) exposed cards, four (4) snitch/informer cards, twelve (12) trivia cards, a bully wildcard, a target wildcard, three (3) each of bully & target category cards for each of domestic, disable, workplace, classroom & cyber categories (block 402). The method 400 includes dealing seven (7) playing cards to each player of a total number of players that is a range between two (2) and six (6) (block 404). Each player also receives ten (101o) gaming chips (block 406). Each player places one (1) chip in the pot (block 408). Play passes to the player on the right (block 410). In the first instance, the player whose turn it is to play is to the immediate left of the player that dealt the hands. The method 400 includes determining whether five (5) rounds have occurred (decision block 412). In response to determining in decision block 412 that five (5) rounds have occurred, then the player with the most chips is deemed to have won (block 414). Method 400 then ends. In response to determining in decision block 412 that five (5) rounds have not occurred, the method 400 includes determining whether the player is out of gaming chips (decision block 416). In response to determining in decision block 416 that the player is out of gaming chips, the player is deemed to be out of the game (block 417). Play then returns to block 410 to pass play to the next player. In response to determining in decision block 416 that the player is not out of gaming chips, then the player determines whether they have a trivia card in their hand (decision block 418). In response to determining in decision block 418 that the player has a trivia card, then the player asks or answers the trivia question printed on the trivia card (block 420). Play then returns to block 410 to pass play to the next player.

In response to determining in decision block 418 that the player does not have a trivia card, then the player draws a card from the undealt portion of the playing card deck (block 422). The method 400 includes determining whether the drawn card is a trivia card (decision block 424). In response to determining in decision block 424 that a trivia card was drawn, and then the player asks or answers the trivia question printed on the trivia card (block 420). Play then returns to block 410 to pass play to the next player.

In response to determining in decision block 424 that a trivia card was not drawn, then a determination is made as to whether the player can complete all of the categories of another player's spread to cancel the spread (decision block 426). The other player's spread would have three categories represented, perhaps with one substituted by a wildcard. The player cancelling the spread would provide the other two categories, perhaps with one substituted by a wildcard. In response to completing the spread in decision block 426, the player collects the chip from the cancelled spread (block 428). Player then returns to block 410 to pass play to the next player.

In response to determining in decision block 426 that another player's spread was not completed and thereby cancelled, then the player looks for a target spread or a bully spread of three (3) of five (5) unique cards all in either the target categories or in the bully categories. The player also looks for four (4) exposed cards to win hand and jackpot (block 430). Method 400 then includes determining whether the player has a target spread or a bully spread (block 432). In response to not finding a target spread of a bully spread or four exposed cards, then the player discards one card (block 434) and play then returns to block 410 to pass play to the next player. In response to finding a target spread of a bully spread, the player places the target spread or bully spread face up on the table (block 436). Each other player starting with the player to the immediate left is obligated to play an informer/snitch card on the target spread or an exposed bully card on the bully spread, respectively, if held (block 438). Method 400 includes a determination as to whether the target spread or bully spread has been cancelled (decision block 440). In response to the determination in decision block 440 that the spread was cancelled, the player gives three (3) gaming chips to the player with the informer/snitch card (2 chips) or exposed card (3 chips)—(block 442). Play then returns to block 410 to pass play to the next player. In response to the determination in decision block 440 that the spread was not cancelled, the player may place one (1) gaming chip on the target spread or bully spread to prevent an informer/snitch card or exposed card that is subsequently drawn by another player in a later turn from cancelling the spread (block 444). Play then returns to block 410 to pass play to the next player.

In the above described flow chart of FIG. 4, the method may be embodied in an automated entertainment system that performs a series of functional processes to create a virtual, randomized deck of cards and virtual other players who play the game according to the rules. Alternatively, a network system or ad hoc network can allow multiple human players to interact through an application (“app”) that performs aspects of the methods described herein. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

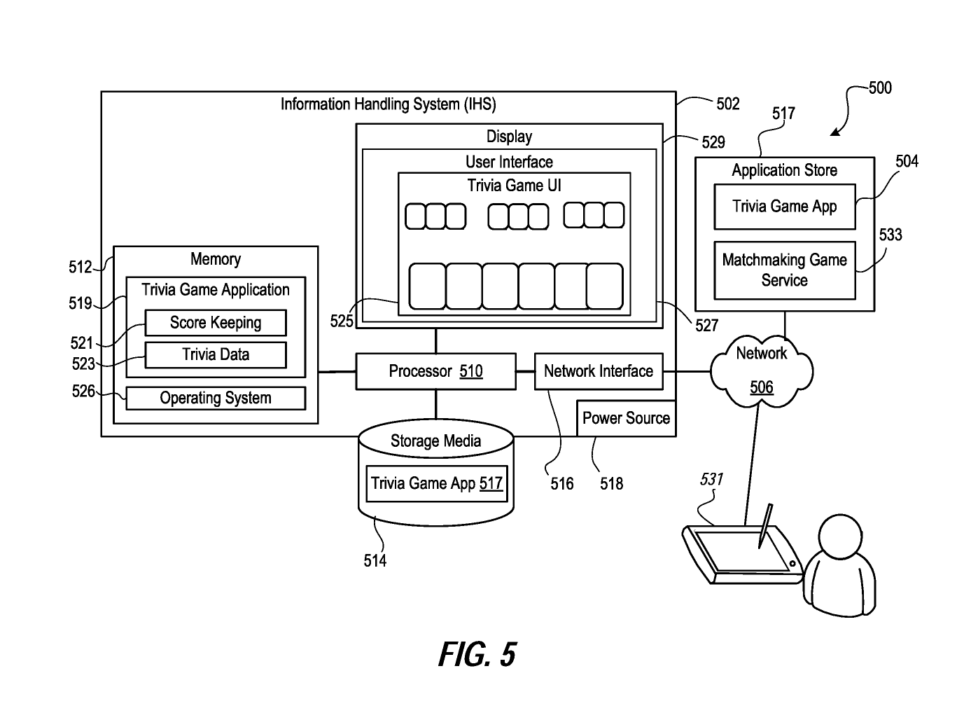

FIG. 5 illustrates a communication system 500 including an information handling system (IHS) 502 for executing a trivia card game 504 over a network 506. For purposes of this disclosure, an information handling system, such as IHS 502, may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a handheld device, personal computer, a server, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components. In one or more embodiments, the game may be based on an electronic game system including over the internet, video gaming devices, table top video terminals, VLT terminals, eTables, mobile games, PC based card games, home card games played upon TV or the internet, home console gaming systems such as XBOX and Nintendo or any digital application that plays cards. Also, play of an electronic card game can be scored in any denomination of scoring, counting, digital-based chips, currency, credit, or monetary value.

In a particular embodiment, the IHS 502 includes a processor 510, a memory 512 communicatively coupled to processor 510, storage media 514, a network interface 516 communicatively coupled to processor 510, and a power source 518 electrically coupled to processor 510. Processor 510 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 510 may interpret and/or execute program instructions and/or process data stored in memory 512 and/or another component of IHS 502. Memory 512 may be communicatively coupled to processor 510 and may include any system, device, or apparatus configured to retain program instructions and/or data for a period of time (e.g., computer-readable media). By way of example without limitation, memory 512 may include RAM, EEPROM, a PCMCIA card, flash memory, magnetic storage, opto-magnetic storage, or any suitable selection and/or array of volatile or non-volatile memory that retains data after power to IHS 502 is turned off or power to IHS 502 is removed. Network interface 516 may include any suitable system, apparatus, or device operable to serve as an interface between IHS 502 and network 506. Network interface 516 may enable the IHS 502 to communicate over network 506 using any suitable transmission protocol and/or standard, including without limitation all transmission protocols and/or standards enumerated herein with respect to the discussion of network 506.

In one or more embodiments, the processor 510 requests the trivia game application (“app”) 504 over the network 506 from an application store 517 and stores a local copy of the trivia card game 504 in the storage media 514. The processor 524 can then access the local copy 519 of the trivia card game 504 and execute a dynamic copy 519 of the trivia card game 504 that is resident in memory 512 with an operating system 526. Data and game parameters such as score keeping 521 and trivia data 523 can also be resident in game as manipulated by the dynamic copy 519. A user interacts with a trivia game user interface (UI) 525 of the dynamic copy 519 via a user interface 527, such as presented on a display 529. The dynamic copy 519 can emulate other players or communicate with another IHS 531 of another user that is arranged by a matchmaking game serviced 533 over the network 506.

Games of the invention may also include game scorecards, a cork board or other means for displaying the game board, game tokens, or pieces, game cards, or other means to mark progress on the game board, challenge reward symbols, such as star stickers or other reward symbols, score recording materials, such as a pencil or a pen and a scorecard or a digital or virtual scorekeeping device, a plurality of journals (one for each player), a game instruction CD, and the like.

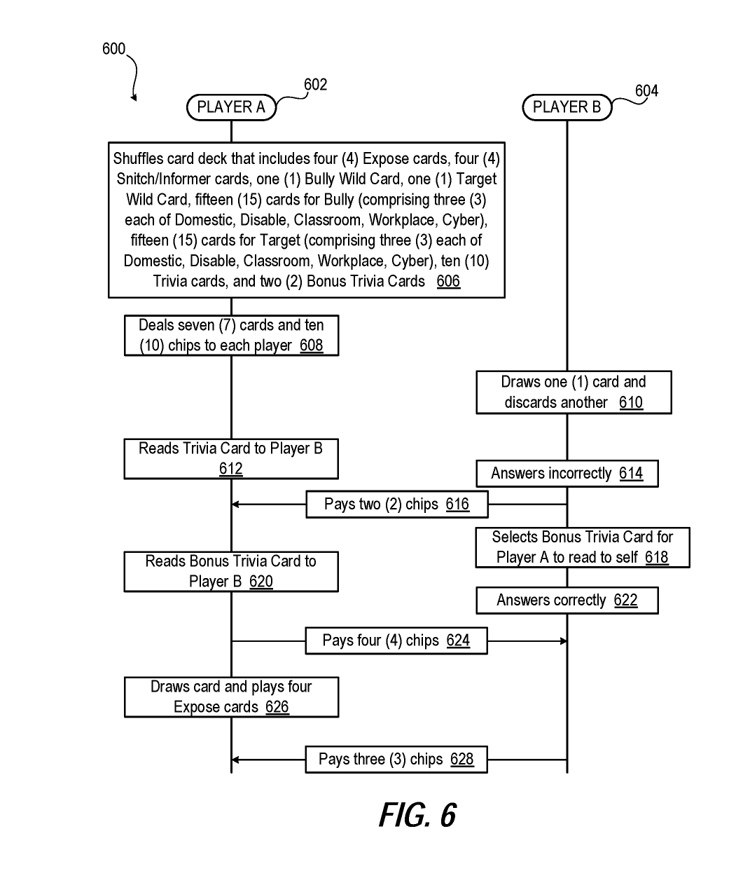

FIG. 6 illustrates a method 600 of playing the game between a player A 602 and a player B 604. Player A 602 shuffles a card deck that includes four (4) exposed cards, four (4) snitch/informer cards, one (1) bully wild card, one (1) target wild card, fifteen (15) cards for bully (comprising three (3) each of domestic, disable, classroom, workplace, cyber), fifteen (15) cards for target (comprising three (3) each of domestic, disable, classroom, workplace, cyber), ten (10) trivia cards, and two (2) bonus trivia cards (block 606). Player A 602 deals seven (7) cards to each player (block 608). Play A passes to Player B 604 who draws one (1) card from the deck and discards one from his hand when unable to make another play (block 610). Player A 602 uses his turn to read a trivia card to player B 604 (block 612). Player B 604 answers incorrectly (block 614). Player B 604 then pays two (2) chips to player A 602). For his turn, player B 604 selects a bonus trivia card to player A 602 to read to player B 604 (block 618). Player A 602 reads the bonus trivia card to player B 604 (block 620). Player B 604 answers correctly (block 622). Player A 602 pays player B 604 four (4) chips (block 624). For his turn, player A 602 draws a card from the deck and plays four (4) Exposed cards (block 626). Player B 604 responds by paying three (3) chips to player A 602 (block 628).

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A playing card game comprising:
a deck of playing cards comprising:
two or more of cards each of a first subset of target categories;
two or more of cards each of a second subset of bully categories; and
at least one snitch/informer card to cancel a played spread of the first subset of target categories; and
at least one exposed card to cancel a played spread of the second subset of bully categories.

2. The playing card game of claim 1, further comprising game chips earned and lost by canceling the played spreads.

3. The playing card game of claim 1, wherein the playing card deck further comprises one or more trivia cards to be asked or answered by a player who takes his turn in a card game.

4. The playing card game of claim 1, wherein the playing card deck further comprises at least one wildcard that can be played in lieu of the first and second subsets.

5. The playing card game of claim 1, wherein:
the two or more cards each of the first subset of target categories comprises three cards each of target categories of domestic, disable, workplace, classroom, and cyberspace; and
the two or more cards each of the second subset of bully categories comprises three cards each of bully categories of domestic, disable, workplace, classroom, and cyberspace.

6. The playing card game of claim 4, further comprising twelve trivia cards to be asked or answered by a player who takes his turn in a card game.

7. The playing card game of claim 5, further comprising:
a target wild card that can be played in lieu of one of the three cards each of the target categories of domestic, disable, workplace; and classroom, and cyberspace; and
a bully wild card that can be played in lieu of one of the three cards each of the bully categories of domestic, disable, workplace; and classroom, and cyberspace.

8. A method of playing a game with a playing card deck including two or more of cards each of a first subset of target categories, two or more of cards each of a second subset of bully categories, and at least one snitch/informer card, and at least one exposed card and with game chips, the method comprising:
dealing a hand a first number of cards from the playing card deck to two or more players;
providing a second number of game chips to each of the two or more players;
taking turns for each of the two more players for a third number of rounds by:
drawing an undealt card from a remainder of the playing card deck;
laying down a spread of unique cards all taken from the first subset of target categories or all taken from the second subset of bully categories;
receiving respectively the snitch/informer card or the exposed card if held by another player on the spread respectively comprised of the first subset of target categories or the second subset of bully categories; and
in response to receiving the snitch/informer card or exposed card, cancelling the spread.

9. The method of claim 8, further comprising:
in response to receiving the snitch/informer card or exposed card, canceling the spread by giving the other player a fourth number of game chips that are held by the player; and
declaring a player with the most game chips as winner of the game after the third number of rounds.

10. The method of claim 8, wherein the playing card deck comprises one or more trivia cards, the method further comprising:
drawing a trivia card; and
asking or answering a trivia question in response to drawing the trivia card.

11. The method of claim 8, wherein the playing card deck comprises at least one wildcard that can be played in lieu of the first and second subsets.

12. A method of playing a game with a playing card deck including three cards each of a first subset of target categories of domestic, disable, workplace, classroom, and cyberspace, three cards each of a second subset of bully categories of domestic, disable, workplace, classroom, and cyberspace, four snitch/informer cards, and four exposed cards and with game chips, the method comprising:
dealing a hand a first number of cards from the playing card deck to two to six players;
providing a second number of game chips to each of the two or more players;
taking turns for each of the two more players for a third number of rounds by:
drawing an undealt card from a remainder of the playing card deck;
laying down a spread of unique cards all taken from the first subset of target categories or all taken from the second subset of bully categories;
receiving respectively the snitch/informer card or the exposed card if held by another player on the spread respectively comprised of the first subset of target categories or the second subset of bully categories; and
in response to receiving the snitch/informer card or exposed card, cancelling the spread.

13. The method of claim 12, further comprising:
in response to receiving the snitch/informer card or exposed card, cancelling the spread by giving the other player a fourth number of game chips that are held by the player; and
declaring a player with the most game chips as winner of the game after the third number of rounds.

14. The method of claim 13, wherein playing card deck further comprises twelve trivia cards, the method further comprising:
drawing a trivia card; and
asking or answering trivia in response to drawing the trivia card.

15. The method of claim 14, wherein playing card deck further comprises:
a target wild card that can be played in lieu of one of the three cards each of the target categories of domestic, disable, workplace; and classroom, and cyberspace; and
a bully wild card that can be played in lieu of one of the three cards each of the bully categories of domestic, disable, workplace; and classroom, and cyberspace.
